(19) United States
(12) Patent Application Publication
(10) Pub. No.: US 2015/0273818 A1
(43) Pub. Date: Oct. 1, 2015

(54) Discontinuous Layer Of Auxiliary Transfer Fluid

(71) Applicant: Xerox Corporation, Norwalk, CT (US)

(72) Inventors: David A. Mantell, Rochester, NY (US); Chu-heng Liu, Penfield, NY (US); Srinivas Mettu, Essendon (AU)

(73) Assignee: Xerox Corporation, Norwalk, CT (US)

(21) Appl. No.: 14/230,518

(22) Filed: Mar. 31, 2014

(51) Int. Cl. B41J 2/005

(52) U.S. Cl. CPC B41J 2/0057

(57) ABSTRACT

A device includes a substrate; and a discontinuous layer disposed on a surface of the substrate, wherein the discontinuous layer is formed from non-contiguous drops of auxiliary fluid which do not draw back or pool on the substrate when a fluid drop is deposited thereon. A method for ink jet printing includes providing a discontinuous layer formed from drops of auxiliary fluid on a transfer member, wherein the drops of auxiliary fluid are non-contiguous and do not draw back or pool on the substrate when an ink drop is deposited thereon; ejecting ink droplets to form an ink image on the discontinuous layer; and transferring the ink jet image from the transfer member to a recording medium. An intermediate transfer member of an ink jet printer includes a substrate; and a discontinuous layer disposed on a surface of the substrate. An ink jet printer includes a transfer member; and a discontinuous layer disposed on a surface of the transfer member.

### BACKGROUND

This disclosure is generally directed to discontinuous layers. More particularly, disclosed herein are ink jet transfix apparatuses and methods comprising a discontinuous layer of auxiliary transfer fluid. In particular, disclosed herein is a method, composition, imaging member, and imaging apparatus that improves the wetting and release capability of an aqueous latex ink on low surface energy materials. More particularly, disclosed herein is an imaging member comprising a substrate having disposed thereon a discontinuous layer of auxiliary transfer fluid.

Fluid ink jet systems typically include one or more print heads having a plurality of ink jets from which drops of fluid are ejected towards a recording medium. The ink jets of a print head receive ink from an ink supply chamber or manifold in the print head which, in turn, receives ink from a source, such as an ink reservoir or an ink cartridge. Each ink jet includes a channel having one end in fluid communication with the ink supply manifold. The other end of the ink channel has an orifice or nozzle for ejecting drops of ink. The nozzles of the ink jets may be formed in an aperture or nozzle plate that has openings corresponding to the nozzles of the ink jets. During operation, drop ejecting signals activate actuators in the ink jets to expel drops of fluid from the ink jet nozzles onto the recording medium. By selectively activating the actuators of the ink jets to eject drops as the recording medium and/or print head assembly are moved relative to one another, the deposited drops can be precisely patterned to form particular text and graphic images on the recording medium.

Ink jet printing systems commonly use either a direct printing architecture or an offset printing architecture. In a typical direct printing system, ink is ejected from jets in the print head directly onto the final receiving web or substrate such as paper. In an offset printing system, the image is formed on an intermediate transfer surface and subsequently transferred to the final receiving substrate such as a web or individual substrate such as paper.

In a typical ink jet printing device, the jetted ink image is formed on an intermediate transfer surface or on the final substrate for a direct to final substrate device, by jetting an aqueous, solvent, or phase change (solid) ink onto the intermediate transfer surface or final substrate, and in the case of phase change ink, cooling to a malleable solid intermediate state as the drum (or other imaging member configuration such as belt, etc.) continues to rotate or advance. When the imaging has been completed, a transfer roller is moved into contact with the drum to form a pressurized transfer nip between the roller and the curved surface of the intermediate transfer surface/drum. A final receiving substrate, such as a sheet of paper, is then fed into the transfer nip and the ink image is transferred to the final receiving web. For direct to final substrate devices, a final receiving substrate, such as a sheet of paper, is moved into contact with the drum via a sheet feeding device such as a sheet feeding roller, to form a pressurized transfer nip between the sheet feeding roller and the drum, and the ink image is transferred directly to the final receiving substrate.

During the transfer printing process, various intermediate media (e.g., transfer belts, intermediate blankets or drums) may be used to transfer the formed image to the final substrate. In intermediate transfix processes, aqueous latex ink is jetted onto an intermediate blanket where the ink film is dried with heat. The dried image is subsequently transfixed on to the final paper substrate. For this process to properly operate, the intermediate blanket has to satisfy two conflicting requirements. The first requirement is that ink has to wet to the blanket. The second requirement is that, after drying, the ink should release from the blanket. Since aqueous ink comprises a large amount of water, such ink compositions wet on high energy (i.e., greater than 40 mJ/m²) hydrophilic substrates. However, due to the high affinity to such substrates, the aqueous ink does not release well from these substrates. Silicone rubbers with low surface energy (i.e., about 20 mJ/m² or less) may circumvent the release problem. However, a major drawback of the silicone rubbers is that the ink does not wet on these substrates due to low affinity to water. Thus, the ideal intermediate blanket for the transfix process would have both optimum wetting to form a good quality image and optimum release properties to transfix the image to paper. While some solutions, such as adding surfactants to the ink to reduce the surface tension of the ink, have been proposed, these solutions can present additional problems. For example, the surfactants can result in uncontrolled spreading of the ink that causes the edges of single pixel lines to be undesirably wavy. Moreover, aqueous print heads have certain minimum surface tension requirements (i.e., greater than 20 mN/m) that must be met for good jetting performance.

Therefore, aqueous transfix printing architectures must balance two processes. The first is that when printing the ink onto a surface (blanket) the ink must wet the surface. If the ink doesn't wet the surface, the ink draws back in an uncontrolled/random matter. When the ink draws back excessively, it is not possible to preserve decent image quality. The second is that the ink, which is at least partially dried, must transfer easily from the surface leaving little or no residue behind. As discussed above, these two processes tend to be mutually exclusive: surfaces which wet tend to resist transfer and surfaces with good transfer tend to resist wetting.

One potential way to solve this is to put an auxiliary fluid on the blanket that will cause the colorants in the ink as well as the other ink materials such as resins and latex molecules to crash out (precipitate out) of the ink. The idea is that the blanket can be chosen primary for its release properties if the ink can be printed without draw back. However, the application of layers of such fluids themselves can draw back.

U.S. Pat. 7,926,933, which is hereby incorporated by reference herein in its entirety, describes in the Abstract thereof an ink jet printing method and an ink jet printing apparatus using an intermediate transfer body. In embodiments, color ink and an auxiliary liquid are supplied to ink-attracting portions each having a certain area, the ink-attracting portions being surrounded by an ink-repellent portion. Subsequently, ink dots are transferred to a printing medium, the ink dots being formed by the supplied ink and the supplied liquid. Here, the ink-attracting regions have an area in which a plurality of droplets of the ink and the liquid in total can be received.

U.S. Pat. No. 8,177,351, which is hereby incorporated by reference herein in its entirety, describes in the Abstract thereof in the image-recording of an intermediate transfer system applying an ink jet recording method, reactive liquid reactable with ink formed on the intermediate transfer body. Using the intermediate transfer body having a pattern consisting of lyophilic and lyophobic sections on a surface thereof, the reactive liquid is uniformly applied to the intermediate transfer body to form a layer having a suitable thickness.

U.S. Patent Publication 2012/0105561, which is hereby incorporated by reference herein in its entirety, describes in the Abstract thereof a transfer inkjet recording method includes the step of applying an aggregating agent onto an image-forming face of an intermediate transfer member, having a pattern including lyophilic portions and a lyophobic portion, the step of forming an intermediate image by applying an ink onto the image-forming face, and the step of transferring the intermediate image to a recording medium from the image-forming face. The lyophilic portions include at least two types of portions having different areas.

U.S. Pat. No. 7,314,510, which is hereby incorporated by reference herein in its entirety, describes in the Abstract thereof an ink jet liquid composition including chitosan and a non-volatile organic acid. The non-volatile organic acid preferably has two or more carboxyl groups and a cyclic structure other than an aromatic ring. Further, the invention provides an ink jet recording method of forming images on a recording medium surface by ejecting an ink and a liquid composition thereon so that the ink and the liquid are in contact with each other, wherein the ink contains a colorant, the liquid composition contains a component for coagulating the colorant, and the component for coagulating the colorant contains chitosan and a non-volatile organic acid.

U.S. Pat. No. 6,357,870, which is hereby incorporated by reference herein in its entirety, describes in the Abstract thereof a method of printing uses a liquid applicator to apply a coating solution containing polyvinyl pyrrolidone or a polyvinyl pyrrolidone copolymer to an intermediate transfer medium. An image is printed onto the intermediate transfer medium using an ink jet printing device. The coating solution contains an organic solvent, which is preferably a glycol solvent or a diol solvent.

U.S. Pat. No. 6,398,357, which is hereby incorporated by reference herein in its entirety, describes in the Abstract thereof a method of printing uses an inkjet print head to print an ink containing about 0.01 to about 15 wt. % of a wetting agent onto an intermediate transfer surface to form an image on the intermediate transfer surface. The method transfers the image from the intermediate transfer surface to a final medium while the ink is partially wet. The wetting agent may be a 1,2-alkyldiol having 4-10 carbon atoms or a diether alcohol having 6-14 carbon atoms. 1,2-hexanediol and hexylcarbitol, respectively, are particularly suitable wetting agents. If 1,2-hexanediol is used as the wetting agent, the ink may contain about 1.0 to about 5.0 wt. % hexanediol. If hexylcarbitol is used as the wetting agent, the ink may contain about 0.1 to about 2.5 wt. % of hexylcarbitol. The intermediate transfer surface may be coated with a coating solution. In this case, the ink should have a surface energy different from that of the coating solution by no more than about 10 dynes/cm. The coating solution may contain polyvinyl pyrrolidone, and, if so, about 0.01 to about 20 wt. % PVP is suitable. The PVP should have a molecular weight greater than about 400,000.

U.S. Patent Publication 2009/0079784, which is hereby incorporated by reference herein in its entirety, describes in the Abstract thereof an image forming method for forming an image on an image formation body by using an ink liquid including a coloring material and an aggregation treatment agent including a component that causes the coloring material to aggregate. The image forming method includes: an aggregation treatment layer formation step of forming, on the image formation body, a semisolid aggregation treatment layer that includes the aggregation treatment agent and has a moisture content ratio not more than 56%; an ink droplet deposition step of ejecting droplets of the ink liquid and depositing the droplets of the ink liquid onto the image formation body where the aggregation treatment layer has been formed; and a solvent removal step of removing a liquid solvent present on the image formation body after the ink droplet deposition step.

U.S. Patent Publication 2012/0105525, which is hereby incorporated by reference herein in its entirety, describes in the Abstract thereof an inkjet ink and an intermediate transfer medium for inkjet printing. During inkjet printing, the inkjet ink forms ink drops (D₁, D₂) having a contact angle (θ) of less than or equal to 50° on the intermediate transfer medium, where the contact angle (θ) reduces or substantially eliminates coalescence of adjacent ink drops (D₁, D₂). The contact angle (θ) may be obtained by controlling a property of the inkjet ink and/or a property of the surface of the intermediate transfer medium.

Currently available transfer printing systems and methods are suitable for their intended purposes. However a need remains for improved transfer printing systems and methods. Further, a need remains for an improved transfer printing member that exhibits sufficient wetting characteristics, reduces or eliminates ink draw back, and exhibits good ink transfer properties including ink transfer from the printing member surface with little or no ink residue left behind on the printing member surface. Further, a need remains for a system and method to provide the desired spreading and release properties for aqueous inks to address the above problems faced in transfix process.

The appropriate components and process aspects of the each of the foregoing U.S. Patents and Patent Publications may be selected for the present disclosure in embodiments thereof. Further, throughout this application, various publications, patents, and published patent applications are referred to by an identifying citation. The disclosures of the publications, patents, and published patent applications referenced in this application are hereby incorporated by reference into the present disclosure to more fully describe the state of the art to which this invention pertains.

### SUMMARY

Described is a method for ink jet printing comprising providing a discontinuous layer formed from drops of auxiliary fluid on a transfer member, wherein the drops of auxiliary fluid are non-contiguous and do not draw back or pool on the substrate when an ink drop is deposited thereon; ejecting ink droplets to form an ink image on the discontinuous layer; and transferring the ink jet image from the transfer member to a recording medium.

Also described is a device comprising a substrate; and a discontinuous layer disposed on a surface of the substrate, wherein the discontinuous layer is formed from non-contiguous drops of auxiliary fluid which do not draw back or pool on the substrate when a fluid drop is deposited thereon.

Also described is an intermediate transfer member of an ink jet printer comprising a substrate; and a discontinuous layer disposed on a surface of the substrate, wherein the discontinuous layer is formed from non-contiguous drops of auxiliary fluid which do not draw back or pool on the substrate so that when an ink drop is deposited it can interact with many of the non-contiguous drops.

Also described is an ink jet printer comprising a transfer member; a station adjacent said transfer member that provides a discontinuous layer onto the transfer member wherein the discontinuous layer is formed from non-contiguous drops of auxiliary fluid which do not draw back or pool on the substrate when an ink drop is deposited thereon; a print head adjacent said transfer member that ejects aqueous ink droplets onto to discontinuous layer to form ink images on the discontinuous layer; a transfixing station located adjacent said transfer member and downstream from said print head, the transfixing station having a transfixing roll forming a transfixing nip therewith at said transfixing station; and a transporting device for delivering a recording medium to the transfixing nip wherein the ink image is transferred to the recording medium.

### BRIEF DESCRIPTION OF THE DRAWINGS

FIG. 1 is a schematic diagram illustrating an aqueous ink jet printer.

FIG. 2 is an illustration showing an ink drop in relation to a discontinuous layer comprising auxiliary fluid drops in accordance with the present disclosure.

FIG. 3 is an illustration showing auxiliary fluid drops starting to diffusing into deposited ink in accordance with the present disclosure.

FIG. 4 is an illustration showing auxiliary fluid drops diffused into ink drops.

FIG. 5 is an illustration of a discontinuous layer of deposited onto the surface of an intermediate transfer member by ultrasonic mist deposition in accordance with the present disclosure.

### DETAILED DESCRIPTION

A discontinuous fluid coating is described. In embodiments, a device comprising a substrate and a discontinuous layer disposed on a surface of the substrate is provided, wherein the discontinuous layer comprises or is formed from non-contiguous drops of auxiliary fluid which do not draw back or pool on the substrate when a fluid drop is deposited thereon. Under some deposition conditions, individual drops may touch and draw together into single drops but the final layer then consists of either individual drops or these single drops which formed from these combined drops. The fluid drops can, however, interact with the non-contiguous drops forming the discontinuous layer. In embodiments, at least some of the drops of auxiliary fluid are non-contiguous drops that are formed from one or more deposited drops that combined into a single drop on the blanket.

The discontinuous layer comprises non-contiguous drops of auxiliary fluid which do not draw back or pool. This encompasses that some drops may touch and then combine after deposition but overall this touching and combination does not get to the point of pooling. The phenomenon may be considered as one of scale. In the instant embodiments, the drops are considered to be smaller than a pixel whereas pooling occurs on a scale of multiple pixels.

The concept of pooling is known to those of skill in the art. In embodiments, pooling, as used herein, can be defined as the coalescence of multiple droplets to form a large drop approaching the size of a pixel, in embodiments, about 40 micrometers, or approaching or exceeding the size of a pixel, or greater than half the wide of a pixel. In embodiments, the typical drops should be much smaller than a pixel.

In embodiments, the discontinuous layer provides a fluid that contains treatment agents that cause colorants and or resin to aggregate and collect on an imaging member. The treatment agent can include an aggregation treatment agent including those agents that cause crashing or precipitation. The treatment agent can also be an auxiliary treatment agent having additional uses selected as desired such as modifying surface tension of the ink when it lands. In other embodiments, the discontinuous layer provides a precoating in aqueous transfix printing systems.

In embodiments, a discontinuous layer of many very small drops of an auxiliary fluid is first deposited on an entire blanket. Because the drops forming the discontinuous layer are small, they do not form a continuous layer. On low surface energy substrates, continuous fluid layers tend to be unstable and will tend to break up into large pools. Isolated drops are not subject to such instability. A large number of small drops are employed such that they will be within the radius of any ink drop that is deposited. As soon as the ink drop hits the auxiliary fluid, the colorant and other ink components such as pigment and/or resin will begin to crash (or precipitate) out of the ink. Each bit of pigment and/or resin that deposits on the blanket then acts to pin the ink drops preventing ink draw back. The active components in the auxiliary fluid continue to mix with the ink causing additional aggregating of the colorants and other ink components.

The discontinuous layer herein is formed from a large number of small drops. By small drops, it is meant that the drops have an average drop size, also referred to as particle size (such as volume average particle diameter or longest dimension) of from about 0.1 to about 4 micrometers (μm), or about 0.25 to about 2.5 μm, or about 0.5 to about 2 μm. Herein, “average” particle or drop size is typically represented as d₅₀, or defined as the volume median particle size value at the 50th percentile of the particle size distribution, wherein 50% of the particles in the distribution are greater than the d₅₀ particle size value, and the other 50% of the particles in the distribution are less than the d₅₀ value. Average particle size can be measured by methods that use light scattering technology to infer particle size, such as Dynamic Light Scattering. The particle diameter refers to the length of an individual drop of the discontinuous layer as derived from images of the particles generated by Transmission Electron Microscopy or from Dynamic Light Scattering measurements.

By large number of small drops, it is meant that there are from about 250,000 to about 25, or from about 35,000 to about 600, or from about 1,000 to about 400 drops in a 600 dpi pixel section of the discontinuous layer.

When small drops containing water (or some other solvent) are applied to the surface, they will tend to shrink as the water evaporates thus enabling larger number of deposited drops. Drying of the drops to some level is included within the scope of the present embodiments and contemplates using the present method and drying the majority of the fluid from the drops before printing so that one is not actually printing on fluid drops but dried residues of fluid drops.

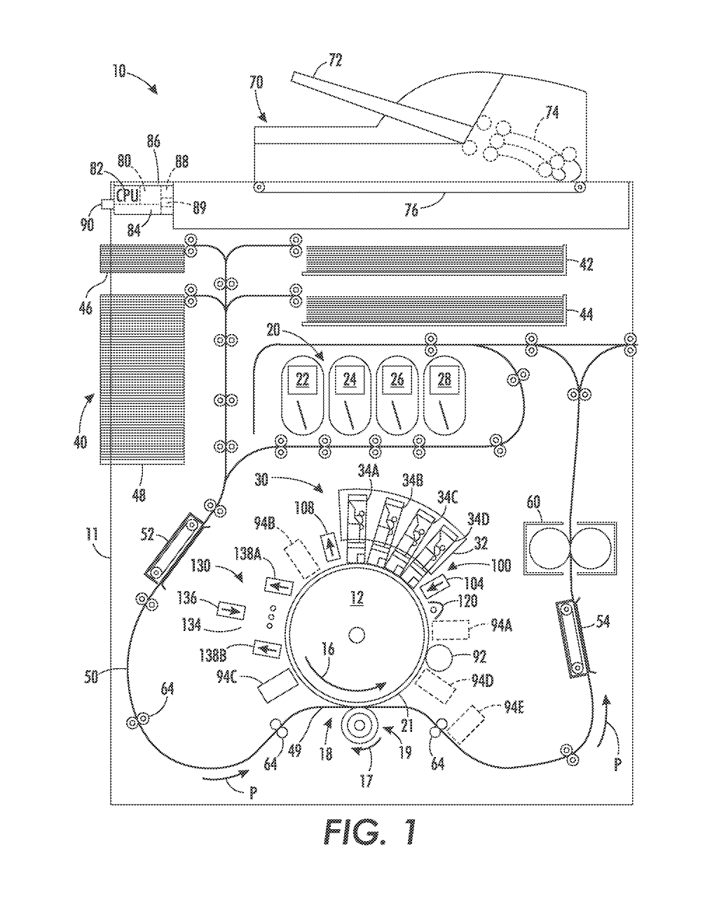

Referring to FIG. 1, a high-speed aqueous ink image producing machine or printer 10 is shown. As illustrated, the printer 10 is an indirect printer that forms an ink image on a surface of a transfer member 12, (also referred to as a blanket or receiving member or image member) and then transfers the ink image to media passing through a nip 18 formed with the transfer member 12. The printer 10 includes a frame 11 that supports directly or indirectly operating subsystems and components, which are described below. The printer 10 includes the transfer member 12 that is shown in the form of a drum, but can also be configured as a supported endless belt. The transfer member 12 has an outer surface 21. The outer surface 21 is movable in a direction 16, and on which ink images are formed. A transfix roller 19 rotatable in the direction 17 is loaded against the surface 21 of transfer member 12 to form a transfix nip 18, within which ink images formed on the surface 21 are transfixed onto a media sheet 49.

The transfer member 12 can be of any suitable configuration. Examples of suitable configurations include a sheet, a film, a web, a foil, a strip, a coil, a cylinder, a drum, an endless strip, a circular disc, a drelt (a cross between a drum and a belt), a belt including an endless belt, an endless seamed flexible belt, and an endless seamed flexible imaging belt. The transfer member 12 can be a single layer or multiple layers.

The transfer member 12 in the transfix process has a conformability which is measured by Shore A durometer. The conformability improves transfer of the aqueous ink images. Typically, the Shore A durometer is form about 20 to about 70, or from about 25 to about 60 or from about 30 to about 50.

The surface 21 of transfer member 12 is formed of a material having a relatively low surface energy to facilitate transfer of the ink image from the surface 21 to the media sheet 49 in the nip 18. Such materials include silicone, fluorosilicone, and fluoroelastomers such as Viton®. Low energy surfaces, however, do not aid in the formation of good quality ink images as they do allow wetting of ink drops as well as high energy surfaces. Disclosed in more detail below is a discontinuous layer method and apparatus that improves the wetting ability of the ink to provide good ink images while allowing for proper release of the ink images onto the recording substrate 49.

Continuing with the general description, the printer 10 includes an optical sensor 94A, also known as an image-on-drum (“IOD”) sensor, that is configured to detect light reflected from the surface 21 of the transfer member 12 and the coating applied to the surface 21 as the member 12 rotates past the sensor. The optical sensor 94A includes a linear array of individual optical detectors that are arranged in the cross-process direction across the surface 21 of the transfer member 12. The optical sensor 94A generates digital image data corresponding to light that is reflected from the surface 21. The optical sensor 94A generates a series of rows of image data, which are referred to as “scanlines,” as the transfer member 12 rotates in the direction 16 past the optical sensor 94A. In one embodiment, each optical detector in the optical sensor 94A further comprises three sensing elements that are sensitive to frequencies of light corresponding to red, green, and blue (RGB) reflected light colors. The optical sensor 94A also includes illumination sources that shine red, green, and blue light onto the surface 21. The optical sensor 94A shines complementary colors of light onto the image receiving surface to enable detection of different ink colors using the RGB elements in each of the photodetectors. The image data generated by the optical sensor 94A is analyzed by the controller 80 or other processor in the printer 10 to identify the thickness of ink image and discontinuous coating (discontinuous layer explained in more detail below) on the surface 21 and the area coverage. The thickness and coverage can be identified from either specular or diffuse light reflection from the blanket surface and coating. Other optical sensors, such as 94B, 94C, and 94D, are similarly configured and can be located in different locations around the surface 21 to identify and evaluate other parameters in the printing process, such as missing or inoperative inkjets and ink image formation prior to image drying (94B), ink image treatment for image transfer (94C), and the efficiency of the ink image transfer (94D). Alternatively, some embodiments can include an optical sensor to generate additional data that can be used for evaluation of the image quality on the media (94E).

The printer 10 also can include a surface energy applicator 120 positioned next to the surface 21 of the transfer member 12 at a position immediately prior to the surface 21 entering the print zone formed by print head modules 34A-34D. The surface energy applicator 120 can be, for example, a corotron, a scorotron, or a biased charge roller. The surface energy applicator 120 is configured to emit an electric field between the applicator 120 and the surface 21 that is sufficient to ionize the air between the two structures and apply negatively charged particles, positively charged particles, or a combination of positively and negatively charged particles to the surface 21. The electric field and charged particles increase the surface energy of the blanket surface and coating. The increased surface energy of the surface 21 enables the ink drops subsequently ejected by the print heads in the modules 34A-34D to adhere to the surface 21 and coalesce.

The printer 10 includes an airflow management system 100, which generates and controls a flow of air through the print zone. The airflow management system 100 includes a print head air supply 104 and a print head air return 108. The print head air supply 104 and return 108 are operatively connected to the controller 80 or some other processor in the printer 10 to enable the controller to manage the air flowing through the print zone. This regulation of the air flow helps prevent evaporated solvents and water in the ink from condensing on the print head and helps attenuate heat in the print zone to reduce the likelihood that ink dries in the inkjets, which can clog the inkjets. The airflow management system 100 can also include sensors to detect humidity and temperature in the print zone to enable more precise control of the air supply 104 and return 108 to ensure optimum conditions within the print zone. Controller 80 or some other processor in the printer 10 can also enable control of the system 100 with reference to ink coverage in an image area or even to time the operation of the system 100 so air only flows through the print zone when an image is not being printed.

The high-speed aqueous ink printer 10 also includes an aqueous ink supply and delivery subsystem 20 that has at least one source 22 of one color of aqueous ink. Since the illustrated printer 10 is a multicolor image producing machine, the ink delivery system 20 includes four (4) sources 22, 24, 26, 28, representing four (4) different colors CYMK (cyan, yellow, magenta, black) of aqueous inks. In the embodiment shown in FIG. 1, the print head system 30 includes a print head support 32, which provides support for a plurality of print head modules, also known as print box units, 34A through 34D. Each print head module 34A-34D effectively extends across the width of the intermediate transfer member 12 and ejects ink drops onto the surface 21. A print head module can include a single print head or a plurality of print heads configured in a staggered arrangement. Each print head module is operatively connected to a frame (not shown) and aligned to eject the ink drops to form an ink image on the surface 21. The print head modules 34A-34D can include associated electronics, ink reservoirs, and ink conduits to supply ink to the one or more print heads. In the illustrated embodiment, conduits (not shown) operatively connect the sources 22, 24, 26, and 28 to the print head modules 34A-34D to provide a supply of ink to the one or more print heads in the modules. As is generally familiar, each of the one or more print heads in a print head module can eject a single color of ink. In other embodiments, the print heads can be configured to eject two or more colors of ink. For example, print heads in modules 34A and 34B can eject cyan and magenta ink, while print heads in modules 34C and 34D can eject yellow and black ink. The print heads in the illustrated modules are arranged in two arrays that are offset, or staggered, with respect to one another to increase the resolution of each color separation printed by a module. Such an arrangement enables printing at twice the resolution of a printing system only having a single array of print heads that eject only one color of ink. Although the printer 10 includes four print head modules 34A-34D, each of which has two arrays of print heads, alternative configurations include a different number of print head modules or arrays within a module.

After the printed image on the surface 21 exits the print zone, the image passes under an image dryer 130. The image dryer 130 includes an infrared heater 134, a heated air source 136, and air returns 138A and 138B. The infrared heater 134 applies infrared heat to the printed image on the surface 21 of the transfer member 12 to evaporate water or solvent in the ink. The heated air source 136 directs heated air over the ink to supplement the evaporation of the water or solvent from the ink. The air is then collected and evacuated by air returns 138A and 138B to reduce the interference of the air flow with other components in the printing area.

As further shown, the printer 10 includes a recording media supply and handling system 40 that stores, for example, one or more stacks of paper media sheets of various sizes. The recording media supply and handling system 40, for example, includes sheet or substrate supply sources 42, 44, 46, and 48. In the embodiment of printer 10, the supply source 48 is a high capacity paper supply or feeder for storing and supplying image receiving substrates in the form of cut media sheets 49, for example. The recording media supply and handling system 40 also includes a substrate handling and transport system 50 that has a media pre-conditioner assembly 52 and a media post-conditioner assembly 54. The printer 10 includes an optional fusing device 60 to apply additional heat and pressure to the print medium after the print medium passes through the transfix nip 18. In one embodiment, the fusing device 60 adjusts a gloss level of the printed images that are formed on the print medium. In the embodiment shown in of FIG. 1, the printer 10 includes an original document feeder 70 that has a document holding tray 72, document sheet feeding and retrieval devices 74, and a document exposure and scanning system 76.

Operation and control of the various subsystems, components and functions of the machine or printer 10 are performed with the aid of a controller or electronic subsystem (ESS) 80. The ESS or controller 80 is operably connected to the image receiving member 12, the print head modules 34A-34D (and thus the print heads), the substrate supply and handling system 40, the substrate handling and transport system 50, and, in some embodiments, the one or more optical sensors 94A-94E. The ESS or controller 80, for example, is a self-contained, dedicated mini-computer having a central processor unit (CPU) 82 with electronic storage 84, and a display or user interface (UI) 86. The ESS or controller 80, for example, includes a sensor input and control circuit 88 as well as a pixel placement and control circuit 89. In addition, the CPU 82 reads, captures, prepares and manages the image data flow between image input sources, such as the scanning system 76, or an online or a work station connection 90, and the print head modules 34A-34D. As such, the ESS or controller 80 is the main multi-tasking processor for operating and controlling all of the other machine subsystems and functions, including the printing process discussed below.

The controller 80 can be implemented with general or specialized programmable processors that execute programmed instructions. The instructions and data required to perform the programmed functions can be stored in memory associated with the processors or controllers. The processors, their memories, and interface circuitry configure the controllers to perform the operations described below. These components can be provided on a printed circuit card or provided as a circuit in an application specific integrated circuit (ASIC). Each of the circuits can be implemented with a separate processor or multiple circuits can be implemented on the same processor. Alternatively, the circuits can be implemented with discrete components or circuits provided in very large scale integrated (VLSI) circuits. Also, the circuits described herein can be implemented with a combination of processors, ASICs, discrete components, or VLSI circuits.

In operation, image data for an image to be produced are sent to the controller 80 from either the scanning system 76 or via the online or work station connection 90 for processing and generation of the print head control signals output to the print head modules 34A-34D. Additionally, the controller 80 determines and/or accepts related subsystem and component controls, for example, from operator inputs via the user interface 86, and accordingly executes such controls. As a result, aqueous ink for appropriate colors are delivered to the print head modules 34A-34D. Additionally, pixel placement control is exercised relative to the surface 21 to form ink images corresponding to the image data, and the media, which can be in the form of media sheets 49, are supplied by any one of the sources 42, 44, 46, 48 and handled by recording media transport system 50 for timed delivery to the nip 18. In the nip 18, the ink image is transferred from the surface 21 of the transfer member 12 to the media substrate within the transfix nip 18.

In some printing operations, a single ink image can cover the entire surface 21 (single pitch) or a plurality of ink images can be deposited on the surface 21 (multi-pitch). In a multi-pitch printing architecture, the surface 21 of the transfer member 12 (also referred to as image receiving member or intermediate transfer member) can be partitioned into multiple segments, each segment including a full page image in a document zone (i.e., a single pitch) and inter-document zones that separate multiple pitches formed on the surface 21. For example, a two pitch image receiving member includes two document zones that are separated by two inter-document zones around the circumference of the surface 21. Likewise, for example, a four pitch image receiving member includes four document zones, each corresponding to an ink image formed on a single media sheet, during a pass or revolution of the surface 21.

Once an image or images have been formed on the surface under control of the controller 80, the illustrated inkjet printer 10 operates components within the printer to perform a process for transferring and fixing the image or images from the surface 21 to media (also referred to as the final image receiving substrate). In the printer 10, the controller 80 operates actuators to drive one or more of the rollers 64 in the media transport system 50 to move the media sheet 49 in the process direction P to a position adjacent the transfix roller 19 and then through the transfix nip 18 between the transfix roller 19 and the surface 21 of transfer member 12. The transfix roller 19 applies pressure against the back side of the recording media 49 in order to press the front side of the recording media 49 against the surface 21 of the transfer member 12. Although the transfix roller 19 can also be heated, in the embodiment of FIG. 1, the transfix roller 19 is unheated. Instead, the pre-heater assembly 52 for the media sheet 49 is provided in the media path leading to the nip. The pre-conditioner assembly 52 conditions the media sheet 49 to a predetermined temperature that aids in the transferring of the image to the media, thus simplifying the design of the transfix roller. The pressure produced by the transfix roller 19 on the back side of the heated media sheet 49 facilitates the transfixing (transfer and fusing) of the image from the transfer member 12 onto the media sheet 49.

The rotation or rolling of both the transfer member 12 and transfix roller 19 not only transfixes the images onto the media sheet 49, but also assists in transporting the media sheet 49 through the nip. The transfer member 12 continues to rotate to continue the transfix process for the images previously applied to the coating and blanket 21.

As shown and described above, the transfer member 12 (or image receiving member or intermediate transfer member) initially receives the ink jet image. After ink drying, the transfer member 12 releases the image to the final print substrate during a transfer step in the nip 18. The transfer step is improved when the surface 21 of the transfer member 12 has a relatively low surface energy. However, a surface 21 with low surface energy works against the desired initial ink wetting (spreading) on the transfer member 12. Unfortunately, there are two conflicting requirements of the surface 21 of transfer member 12. The first aims for the surface to have high surface energy causing the ink to wet (i.e. not bead-up). The second requirement is that the ink image once dried has minimal attraction to the surface 21 of transfer member 12 so as to achieve maximum transfer efficiency (target is 100%), this is best achieved by minimizing the surface 21 surface energy.

To be more specific, the transfer member 12 materials that release the best are among the classes of silicone, fluorosilicone, and fluoroelastomers such as Viton®. They all have low surface energy but provide poor ink wetting. Alternatively, polyurethane and polyimide, may wet very well but do not give up the ink easily.

Low surface energy materials will also provide poor wetting of the auxiliary fluid drops thus reducing the diameter of the drops and helping to insure a discontinuous layer. Drying through evaporation of water or solvents in the drops will also reduce their size, further enabling a large number of deposited drops that maintain a discontinuous layer. By providing the present discontinuous layer onto the surface 21 of the transfer member 12, improved wetting of the ink image on the transfer member 12 is obtained. The ink image is applied to the discontinuous layer.

Returning to FIG. 1, a surface maintenance unit (SMU) 92 includes a coating station for applying the discontinuous layer to the surface 21 of the intermediate transfer member 12. The coating station can further include a coating applicator, a metering blade, and, in some embodiments, a cleaning blade. The coating applicator can further include a reservoir having a fixed volume of auxiliary fluid for forming the discontinuous layer and a resilient donor member, which can be smooth or porous and is mounted in the reservoir for contact with the auxiliary fluid and the metering blade. The discontinuous layer comprising the auxiliary fluid is applied to the surface 21 of transfer member 12 to form a thin layer on the surface 21. The SMU 92 can be operatively connected to a controller 80, to enable the controller to operate the donor member, metering blade and cleaning blade selectively to deposit and distribute the coating material onto the surface 21 of transfer member 12. The SMU 92 can include a dryer positioned between the coating station and the print head to increase to film formation of the wetting enhancement coating.

The surface maintenance unit (SMU) 92 can include any suitable or desired device for depositing the discontinuous layer to the transfer member 12 in any suitable or desired manner. Any suitable or desired method or device can be used to form the discontinuous layer. In embodiments, the discontinuous layer is formed by depositing the auxiliary transfer fluid with an ultrasonic mixing device, a mist printing device, an anilox roller, or a combination thereof. The method for depositing the discontinuous layer can be any method, provided that the deposition method results in a discontinuous layer of non-contiguous or substantially non-contiguous drops, and is not limited to the methods described herein. In embodiments, the discontinuous layer can be applied to the transfer member 12 using an ultrasonic mixer. In another embodiment, the discontinuous layer can be applied using a patterned surface such as an anilox roller.

The discontinuous layer can comprise a random pattern or an ordered pattern. The random patterned discontinuous layer can be applied by any suitable or desired method that results in a random patterned discontinuous layer. For example, an ultrasonic mixer can be employed to provide the discontinuous layer in a random pattern. In embodiments, a discontinuous layer herein can comprise a random pattern, an ordered pattern, or a combination thereof.

An ordered patterned discontinuous layer can be applied by any suitable or desired method that results in an ordered patterned discontinuous layer. For example, an anilox roller can be employed to provide the discontinuous layer in an ordered pattern. In either case, a large number of small drops will be on the surface when a drop of ink is deposited.

In embodiments, a uniform layer of very fine droplets can be deposited using mist printing technology to form the discontinuous layer. Small droplets in the form of a mist (drop sizes are a few microns in diameter) are selected from a cloud of atomized fluid. A stream of this mist is directed to flow over the receiving surface in the direction (or against the direction) of the surface motion. Because the very small drops tend to flow with the air, the deposition by diffusion is limited. Electrostatic methods can be used to enhance and control the deposition by introducing ion flows (such as corona charging) perpendicular to the surface. The mist drops will capture the ions and be forced towards the receiving surface. In addition, the mist drops repel each other and self-organize into a minimal-touching deposition pattern. The balance between sufficient mist drop density and non-touching condition is controlled and achieved. In embodiments, the transfer member, the discontinuous layer, or a combination thereof, is treated by introducing ion flows to control the depositing of the auxiliary transfer fluid.

After transfer, the ink and any diffused auxiliary transfer fluid of the discontinuous layer are fixed to the recording media 49. Another advantage of the present discontinuous layer is that it reduces or eliminates potential life issues associated with the transfer member 12 after many paper touches since the discontinuous layer can “refresh” the surface 21 of the transfer member 12 after each print cycle.

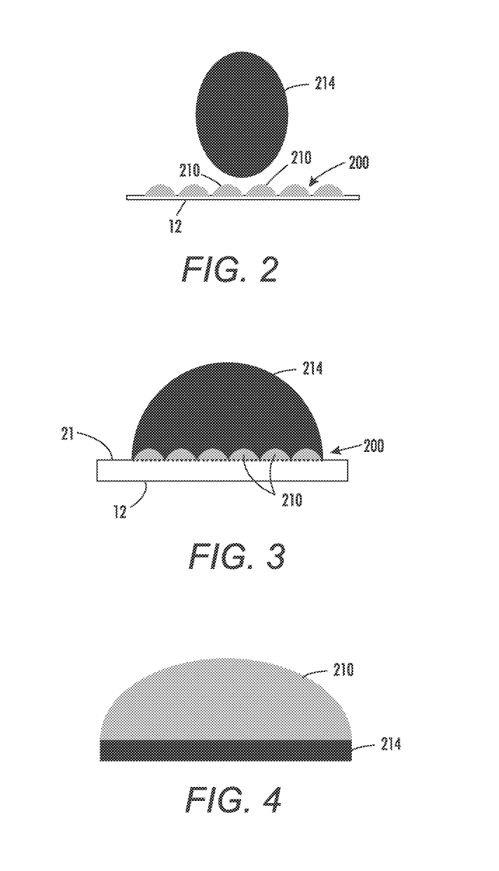

Referring to FIG. 2, a discontinuous layer 200 comprising a large number of small drops 210 are deposited on the surface 21 of the intermediate transfer member 12 (or other substrate as desired). The discontinuous layer 200 is shown in relation to an ink drop 214.

Ink drops, illustrated for simplicity's sake as single ink drop 214, can be applied to the discontinuous layer 200 in any suitable or desired fashion, such as by ink jetting using the aqueous ink jet printer 10 described herein, although not limited.

The discontinuous layer can be applied to any suitable or desired substrate, such as the intermediate transfer member 12, or any other suitable substrate including imaging member components or non-imaging member components.

The drops 210 forming the discontinuous layer 200 can comprise any suitable or desired solution of auxiliary fluid. As noted, the drops 200 do not touch one another, or substantially do not touch one another; that is, drops 200 are non-contiguous, and thus they do not draw back into large pools on the substrate when ink drops, such as ink drop 214, contact the discontinuous layer 200.

By non-contiguous drops, it is meant that the drops do not touch one another or substantially do not touch one another. In a random drop process, the drops will need to be further apart than in a controlled deposition (for example, with an anilox roller). In embodiments, the drops forming the discontinuous layer 200 are disposed from roughly 0.1 to 4 microns distance from one another. The drops do not touch, or substantially do not touch, such that from about 1 to about 20 percent of the non-continuous layer comprises non touching drops. In certain embodiments, a minimal amount of drops can touch and still be within the present embodiments of a non-continuous layer. For example, in a misting system some drops are expected to touch. Those will then draw together to form into a single drop on the blanket. The increase in drop diameter is actually small (if the volume doubles, the diameter increases approximately by cube root or 25% larger diameter than the original drops. In this aspect of the present embodiments, it is acceptable to have multiple drop joining and combining and still form a discontinuous layer within the scope of the present embodiments.

Referring to FIG. 3, when the drop of ink 214 strikes the surface of the discontinuous layer 200 containing the auxiliary fluid drops 210, the pigment (and other ink components such as resin or latex in the ink) starts to precipitate out of the ink. This process starts very quickly leaving a coating of pigment and resin/latex on the surface. This small amount of material on the substrate (for example, imaging member blanket) pins the ink drop 214 on the surface 21. So whereas a drop of ink would normally draw back significantly because of the low surface energy of the blanket relative to the ink, here the deposited material (discontinuous layer 200) acts to pin the ink drop 214 to the surface 21. This leaves time for the auxiliary fluid drops 210 to diffuse through the ink drop 214 and cause further crashing of the ink 214.

FIG. 4 illustrates auxiliary fluid drops 210 diffused through ink drops 16.

In embodiments, the fluid drops are likely to be printed on a blanket that is hot from the previous image transfer. The present discontinuous layer can cool the blanket to an appropriate temperature for the next image to be printed. Evaporation of fluid from the drops of fluid can contribute to this cooling. It is desirable to have the blanket surface cool to prevent large amounts of water from the ink to be evaporated in printed regions that may recondense on the print heads. Alternately, a uniform discontinuous fluid layer may help keep the ink jets through evaporation of water even in regions where there is no image. Thus, extending the time needed before ink drops must be fired to prevent ink drying in the ejector apertures.

The discontinuous layer can be formed using any suitable or desired material provided that the material can form a discontinuous layer of non-contiguous fluid drops. In embodiments, the discontinuous layer can be formed using any suitable or desired auxiliary fluid material provided that the resulting auxiliary fluid can form a discontinuous layer of non-contiguous fluid drops as described herein. In embodiments, the auxiliary fluid forming the discontinuous layer comprises water, an aggregating agent, an optional binder, and an optional surfactant. In other embodiments, the auxiliary fluid forming the discontinuous layer comprises water, a binder, and an optional surfactant.

In embodiments, the discontinuous layer comprises an auxiliary fluid that contains compounds that cause the colorant, such as pigment, or other ink components, such as resin or latex, to crash out of the ink. In embodiments, the discontinuous layer comprises an auxiliary fluid comprising metal salts with metal ions such as Ca, Cu, Ni, Mg, Zn, Fe, and Al salts. In embodiments, the discontinuous layer comprises an auxiliary fluid comprising anions such as Cl, NO₃, SO₄, I, Br, Cl0₃, RCOO— wherein R is an alkyl group having from about 1 to about 1,000 carbon atoms, anions. In certain embodiments, the discontinuous layer comprises an auxiliary fluid comprising iron sulfate, copper sulfate, or a mixture or combination thereof.

In embodiments, the auxiliary fluid forming the discontinuous layer comprises water, a binder selected from the group consisting of acrylic polymers, styrene acrylic polymers, vinyl-acrylic polymers, vinyl acetate ethylene polymers, and an optional surfactant. In certain embodiments, the discontinuous layer herein comprises an aqueous latex-acrylic dispersion comprising water, a binder polymer and a surfactant. The binder is selected from the group consisting of acrylic polymers, styrene acrylic polymers, vinyl-acrylic polymers and vinyl acetate ethylene. The weight percentage of any binder can be from 10 to 60 weight percent. The surfactant is a water soluble siloxane. The concentration of the surfactant can be from 0.1 weight percent to about 2 weight percent, or from about 0.2 weight percent. The surfactant can be a polysiloxane copolymer that includes a polyester modified polydimethylsiloxane, commercially available from BYK Chemical with the trade name of BYK® 310; a polyether modified polydimethylsiloxane, commercially available from BYK Chemical with the trade name of BYK® 330; a polyacrylate modified polydimethylsiloxane, commercially available from BYK Chemical with the trade name of BYK®-SILCLEAN 3700 (about 25 weight percent in methoxypropylacetate); or a polyester polyether modified polydimethylsiloxane, commercially available from BYK Chemical with the trade name of BYK® 375. The surfactant can be a low molecular weight ethoxylated polydimethylsiloxane with the trade name Silsurf® A008 available from Siltech Corporation. For further detail, see U.S. patent application Ser. No. 13/716,892, filed Dec. 17, 2012, of Liu et al., which is hereby incorporated by reference herein in its entirety.

### EXAMPLES

The following Examples are being submitted to further define various species of the present disclosure. These Examples are intended to be illustrative only and are not intended to limit the scope of the present disclosure. Also, parts and percentages are by weight unless otherwise indicated.

### Example 1

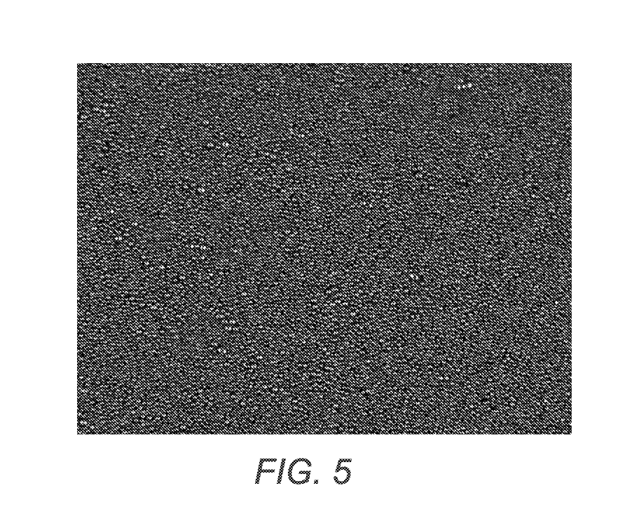

A auxiliary fluid was prepared comprising 10 grams of iron (III) sulfate and 90 grams of water. A discontinuous layer of the aforementioned materials was deposited onto the surface of an intermediate transfer member comprising a silicone plate by ultrasonic mist deposition. The discontinuous layer was examined by optical imaging and shown to comprise a plurality of non-contiguous drops having an average drop size of 10 micrometers in diameter as determined by an image analyzer. The discontinuous layer had an average thickness of about 1 to about 2 micrometers. With reference to FIG. 5, an illustration of the discontinuous layer shows that the droplets are clearly distinct and are not touching. The image is a 1.8 millimeter by 1.35 millimeter. The droplet size is about 10 micrometer in diameter. The droplets are about 2 to about 5 micrometers away from their nearest neighbors.

Thus, in embodiments, a discontinuous layer comprising many tiny non-contiguous drops (micro-dots) of an auxiliary transfer fluid are deposited on a blanket of an aqueous ink jet offset transfer device. Since the auxiliary fluid drops forming the discontinuous layer are small, they do not form a continuous layer and do not coalesce as large touching drops do or as happens when a blanket is flooded with fluid. A large number of small drops of the discontinuous layer thus fall within the diameter of any ink drop that is deposited, such as jetted, on to the discontinuous layer. As soon as the ink drop hits the discontinuous layer formed from the auxiliary fluid, the pigment colorant and/or resin in the ink begins to precipitate out of the ink. In embodiments, the chemical composition of the auxiliary transfer fluid comprising the discontinuous layer is selected to enhance the precipitation of the colorant. The discontinuous layer and precipitated colorant acts to pin the ink drops and further prevent coalescence of the drops forming the discontinuous layer. The components forming the auxiliary fluid continue to mix with the ink causing additional solids to leave solution. The water can then be removed, such as by heating, evaporation, and the like, and the marked spots (image) offset to media (final image receiving substrate).

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

1. A method for ink jet printing comprising:
providing an intermediate transfer member comprising a substrate and a discontinuous layer formed from drops of auxiliary fluid disposed on the substrate, wherein the drops of auxiliary fluid are non-contiguous and do not draw back or pool on the substrate when an ink drop is deposited thereon;
ejecting ink droplets to form an ink image on the discontinuous layer; and
transferring the ink image from the transfer member to a recording medium.

2. The method of claim 1, wherein the discontinuous layer comprises a random pattern.

3. The method of claim 1, wherein the discontinuous layer comprises an ordered pattern.

4. The method of claim 1, wherein the auxiliary fluid forming the discontinuous layer comprises water, an aggregating agent, an optional binder, and an optional surfactant.

5. The method of claim 1, wherein the auxiliary fluid forming the discontinuous layer comprises water, a binder selected from the group consisting of acrylic polymers, styrene acrylic polymers, vinyl-acrylic polymers, vinyl acetate ethylene polymers, and an optional surfactant.

6. The method of claim 1, wherein the discontinuous layer is formed by depositing the auxiliary transfer fluid with an ultrasonic mixing device, an anilox roller, a mist printing device, or a combination thereof.

7. The method of claim 1, wherein the transfer member, the discontinuous layer, or a combination thereof, is treated by introducing ion flows to control the depositing of the auxiliary transfer fluid.

8. The method of claim 1, wherein the drops of auxiliary fluid comprise individual drops having a volume average particle diameter of from about 0.1 to about 4 micrometers.

9. The method of claim 1, wherein at least some of the drops of auxiliary fluid are non-contiguous drops that are formed from one or more deposited drops that combined into a single drop on the substrate.

10. A device comprising:
a substrate; and
a discontinuous layer disposed on a surface of the substrate, wherein the discontinuous layer is formed from non-contiguous drops of auxiliary fluid which do not draw back or pool on the substrate when a fluid drop of ink is deposited thereon.

11. An intermediate transfer member of an ink jet printer comprising:
a substrate; and
a discontinuous layer disposed on a surface of the substrate, wherein the discontinuous layer is formed from non-contiguous drops of auxiliary fluid which do not draw back or pool on the substrate when an ink drop is deposited thereon.

12. The intermediate transfer member of claim 11, wherein the discontinuous layer comprises a random pattern, an ordered pattern, or a combination thereof.

13. The intermediate transfer member of claim 11, wherein the auxiliary fluid forming the discontinuous layer comprises water, an aggregating agent, an optional binder, and an optional surfactant.

14. The intermediate transfer member of claim 11, wherein the drops of auxiliary fluid comprise individual drops having a volume average particle diameter of from about 0.1 to about 4 micrometers.

15. The intermediate transfer member of claim 11, wherein at least some of the drops of auxiliary fluid are non-contiguous drops that are formed from one or more deposited drops that combined into a single drop on the blanket.

16. An ink jet printer comprising:
a transfer member comprising a substrate;
a station adjacent said transfer member that provides a discontinuous layer onto the substrate of the transfer member wherein the discontinuous layer is formed from non-contiguous drops of auxiliary fluid which do not draw back or pool on the substrate when an ink drop is deposited thereon;
a print head adjacent said transfer member that ejects aqueous ink droplets onto to discontinuous layer to form ink images on the discontinuous layer;
a transfixing station located adjacent said transfer member and downstream from said print head, the transfixing station having a transfixing roll forming a transfixing nip therewith at said transfixing station; and
a transporting device for delivering a recording medium to the transfixing nip wherein the ink image is transferred to the recording medium.

17. The ink jet printer of claim 16, wherein the discontinuous layer comprises a random pattern, an ordered pattern, or a combination thereof.

18. The ink jet printer of claim 16, wherein the drops of auxiliary fluid comprise individual drops having a volume average particle diameter of from about 0.1 to about 4 micrometers.

19. The ink jet printer of claim 16, wherein at least some of the drops of auxiliary fluid are non-contiguous drops that are formed from one or more deposited drops that combined into a single drop on the blanket.

20. The ink jet printer of claim 16, wherein the auxiliary fluid forming the discontinuous layer comprises water, an aggregating agent, an optional binder, and an optional surfactant.
